(19) United States
(12) Patent Application Publication
(10) Pub. No.: US 2014/0289632 A1
(43) Pub. Date: Sep. 25, 2014

(54) PICTURE DRAWING SUPPORT APPARATUS AND METHOD

(71) Applicant: KABUSHIKI KAISHA TOSHIBA, Tokyo (JP)

(72) Inventors: Masaru Suzuki, Kawasaki-shi (JP); Masayuki Okamoto, Kawasaki-shi (JP); Kenta Cho, Kawasaki-shi (JP); Kosei Fume, Kawasaki-shi (JP)

(73) Assignee: KABUSHIKI KAISHA TOSHIBA, Tokyo (JP)

(21) Appl. No.: 14/196,435

(22) Filed: Mar. 4, 2014

(30) Foreign Application Priority Data
Mar. 21, 2013 (JP) 2013-058941

(51) Int. Cl. G06F 3/16

(52) U.S. Cl. CPC G06F 3/167
USPC 715/728

(57) ABSTRACT

According to an embodiment, a picture drawing support apparatus includes following components. The feature extractor extracts a feature amount from a picture drawn by a user. The speech recognition unit performs speech recognition on speech input by the user. The keyword extractor extracts at least one keyword from a result of the speech recognition. The image search unit retrieves one or more images corresponding to the at least one keyword from a plurality of images prepared in advance. The image selector selects an image which matches the picture, from the one or more images based on the feature amount. The image deformation unit deforms the image based on the feature amount to generate an output image. The presentation unit presents the output image.

### CROSS-REFERENCE TO RELATED APPLICATIONS

This application is based upon and claims the benefit of priority from Japanese Patent Application No. 2013-058941, filed Mar. 21, 2013, the entire contents of which are incorporated herein by reference.

### FIELD

Embodiments described herein relate generally to a picture drawing support apparatus and method.

### BACKGROUND

A picture drawing support apparatus which supports drawing of a picture by handwriting is known. A conventional picture drawing support apparatus performs figure recognition of a picture drawn by the user, and generates a picture based on the recognition result.

In this picture drawing support apparatus, drawing support succeeds only when a picture drawn by the user is correctly recognized. More specifically, it is difficult to deal with an object other than a simple figure such as a rectangle and characters, and the user has to draw a detailed picture, a figure of which can be successfully recognized, so as to deal with a figure with a complicated shape.

The picture drawing support apparatus is required to be able to support drawing of the user so as to allow the user to easily draw a desired picture.

### BRIEF DESCRIPTION OF THE DRAWINGS

FIG. 1 is a block diagram schematically showing a picture drawing support apparatus according to an embodiment;

FIG. 2 is a flowchart showing a processing sequence example of the picture drawing support apparatus shown in FIG. 1;

FIG. 3 is a view showing an example of a picture drawn by the user;

FIG. 4 is a flowchart showing a processing sequence example of a keyword extractor shown in FIG. 1;

FIG. 5 is a table showing an example of a layout phrase extraction dictionary held by the keyword extractor shown in FIG. 1;

FIG. 6 is a view showing examples of images stored in an image storage unit shown in FIG. 1;

FIG. 7 is a flowchart showing a processing sequence example of an image selector shown in FIG. 1;

FIG. 8 is a flowchart showing a processing sequence example of an image deformation unit shown in FIG. 1;

FIGS. 9A and 9B are views showing examples of deformed images generated by the image deformation unit shown in FIG. 1;

FIG. 10 is a view showing an output image generated by combining the deformed images shown in FIGS. 9A and 9B by the image deformation unit shown in FIG. 1;

FIG. 11 is a view showing another example of a picture drawn by the user; and

FIG. 12 is a view showing an example of an output image generated based on the picture shown in FIG. 11 by the picture drawing support apparatus shown in FIG. 1.

### DETAILED DESCRIPTION

According to an embodiment, a picture drawing support apparatus includes a feature extractor, a speech recognition unit, a keyword extractor, an image search unit, an image selector, an image deformation unit, and a presentation unit. The feature extractor is configured to extract a feature amount from a picture drawn by a user. The speech recognition unit is configured to perform speech recognition on speech input by the user. The keyword extractor is configured to extract at least one keyword from a result of the speech recognition. The image search unit is configured to retrieve one or more images corresponding to the at least one keyword from a plurality of images prepared in advance. The image selector is configured to select an image which matches the picture, from the one or more images based on the feature amount. The image deformation unit is configured to deform the image based on the feature amount to generate an output image. The presentation unit is configured to present the output image.

Various embodiments will be described hereinafter with reference to the accompanying drawings.

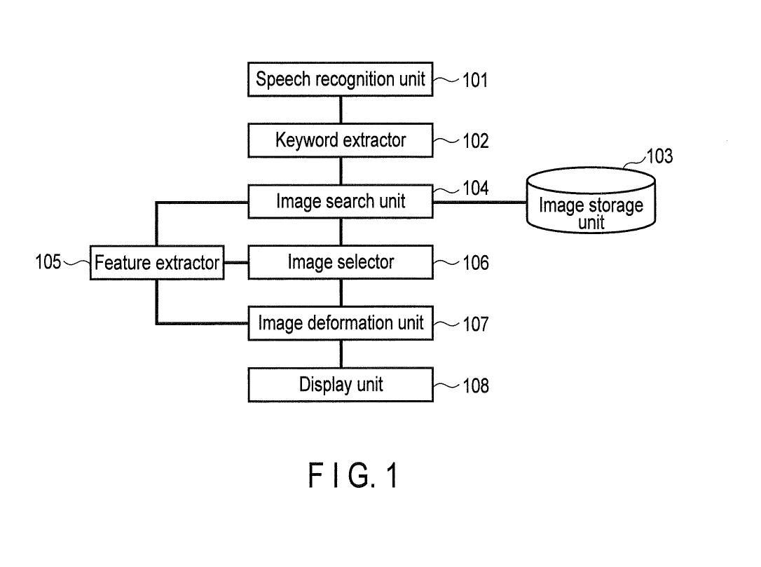

FIG. 1 schematically shows a picture drawing support apparatus according to an embodiment. The picture drawing support apparatus is applicable to a terminal device including a handwriting input interface, which allows a handwriting input by a pen or finger, such as a personal computer (PC), tablet PC, or smartphone. This embodiment assumes a pen input device including a touch panel arranged on a display screen of a display device and a pen for operating the touch panel as the handwriting input interface.

The picture drawing support apparatus shown in FIG. 1 supports the user to draw a picture using speech recognition. More specifically, the picture drawing support apparatus includes a speech recognition unit 101, keyword extractor 102, image storage unit 103, image search unit 104, feature extractor 105, image selector 106, image deformation unit 107, and display unit (also called a presentation unit) 108.

The speech recognition unit 101 performs speech recognition on speech input by the user, and outputs a recognition result including text corresponding to the speech. More specifically, a user's speech is received by an audio input device such as a microphone, and is supplied to the speech recognition unit 101 as speech data. The speech recognition unit 101 applies speech recognition to the speech data, thereby converting the user's speech into text. Speech recognition can be performed by a known speech recognition technique or a speech recognition technique to be developed in the future. Note that when the recognition result is not uniquely determined, the speech recognition unit 101 may output a plurality of recognition result candidates with certainty factors, or may output a sequence of recognition result candidates for respective words as a data structure such as a lattice structure.

The keyword extractor 102 extracts a keyword from the text output from the speech recognition unit 101. As a keyword extraction method, for example, it is possible to utilize a method of applying morphological analysis to the text and extracting an independent word. When the recognition result of the speech recognition unit 101 is a sentence including particles, the keyword extractor 102 may extract a plurality of keywords.

The image storage unit 103 stores data of images, which are registered in advance, in association with tag information. Note that the image storage unit 103 need not be included in the picture drawing support apparatus, but it may be included in another apparatus (for example, a server) which communicates with the picture drawing support apparatus.

The image search unit 104 retrieves an image from the image storage unit 103 based on tag information using a keyword extracted by the keyword extractor 102 as a search key. One or a plurality of images may be retrieved.

The feature extractor 105 extracts a feature amount from a picture which is drawn by the user while vocalizing. Note that vocalization and drawing need not always be performed at the same time, and may be actions having a time lag. For example, the user may draw a picture, and may then input speech corresponding to this picture (that is, speech which expresses this picture), or may draw a corresponding picture after a speech input.

Furthermore, the feature extractor 105 extracts a feature amount from the image retrieved by the image search unit 104. Note that feature extraction processing for a retrieved image need not always be executed after that image is retrieved. For example, images which are prepared in advance may be subjected to feature extraction processing by the feature extractor 105, and may be stored in the image storage unit 103 in association with processing results (that is, feature amounts) and tag information.

The image selector 106 selects an image which matches the drawn picture, from retrieved images based on the feature amount of the drawn picture and those of the retrieved images. Note that “match” means “fit” or “similar”. The image deformation unit 107 deforms the image selected by the image selector 106 according to the feature amount of the drawn picture, and generates an output image (also called an output picture) corresponding to the picture drawn by the user. The display unit 108 displays the output image generated by the image deformation unit 107 so as to present it to the user.

The picture drawing support apparatus according to this embodiment selects an image which matches a picture drawn by the user from a plurality of images prepared in advance using speech recognition, and generates an output image based on the selected image. Thus, the apparatus can support the user to easily draw a desired picture.

The operation of the picture drawing support apparatus according to this embodiment will be described below.

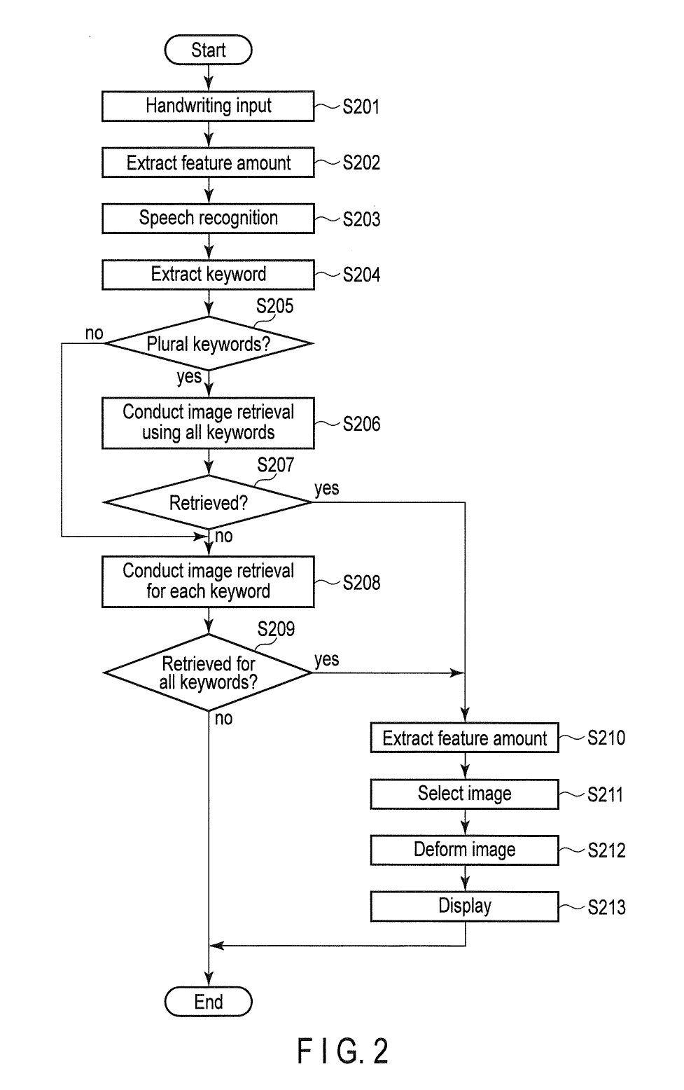

FIG. 2 schematically shows an operation example of the picture drawing support apparatus according to this embodiment. In step S201, the user draws a picture using the pen, and inputs speech corresponding to this picture. In step S202, the feature extractor 105 extracts a feature amount from the picture drawn by the user. In step S203, the speech recognition unit 101 performs speech recognition on the speech input by the user. In step S204, the keyword extractor 102 extracts at least one keyword from the speech recognition result. In step S205, it is checked whether or not a plurality of keywords are extracted by the keyword extractor 102. If one keyword is extracted, the process advances to step S208; if a plurality of keywords are extracted, the process advances to step S206. In step S206, the image search unit 104 retrieves an image, tag information of which includes all these keywords, from the image storage unit 103. It is checked in step S207 whether or not an image is retrieved. If an image is retrieved, the process advances to step S210; otherwise, the process advances to step S208.

In step S208, the image search unit 104 retrieves, for each keyword, an image, tag information of which includes the corresponding keyword. It is checked in step S209 whether or not an image is retrieved respectively for all keywords. If images are retrieved for all keywords, the process advances to step S210; otherwise, the processing ends.

In step S210, the feature extractor 105 extracts a feature amount from a retrieved image. If a plurality of images are retrieved, feature amounts are extracted from respective images. In step S211, the image selector 106 selects an image which matches the drawn picture based on the feature amount of that picture and the feature amounts of the retrieved images.

In step S212, the image deformation unit 107 deforms the image selected by the image selector 106 according to the feature amount of the picture drawn by the user. In step S213, the display unit 108 displays the image deformed by the image deformation unit 107.

In the processing sequence shown in FIG. 2, after the processing for the input picture in step S202, processing for speech is executed in steps S203 to S210. Alternatively, the processing for the picture may be executed after that for the input speech, or the processing for the input picture and that for the input speech may be executed parallelly.

In this embodiment, processing ends except for a case in which images are retrieved for all keywords in step S209, as shown in FIG. 2. In a picture drawing support apparatus according to another embodiment, when images are retrieved for one or more keywords, processes of steps S210 to S213 may be applied to the retrieved images. A handwriting-input picture corresponding to a keyword, for which no image is retrieved, may be displayed intact.

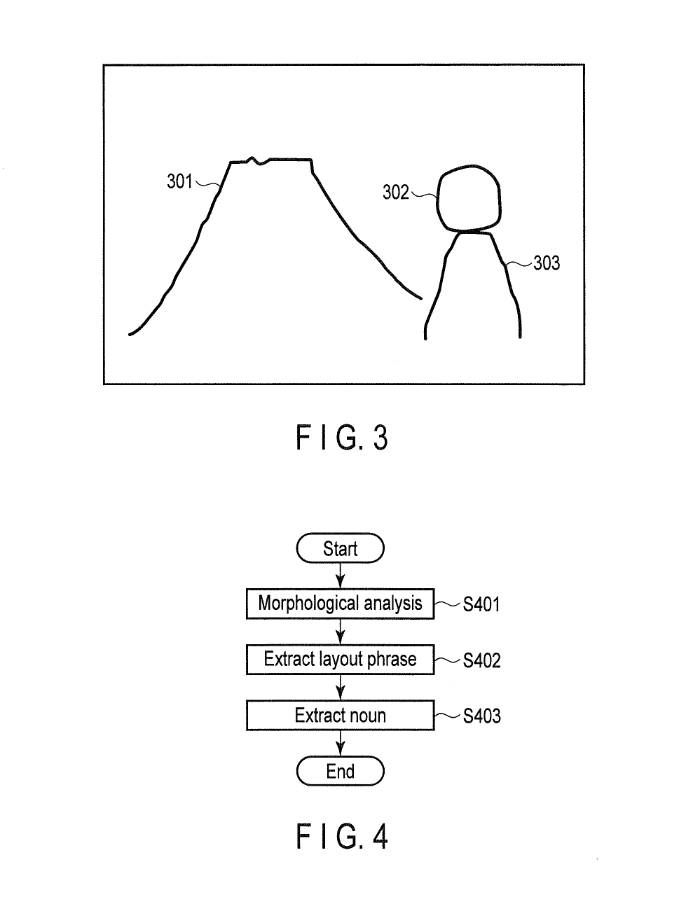

The operation of the picture drawing support apparatus according to this embodiment will be concretely described below. This embodiment will exemplify a case in which the user draws a picture (figures) shown in FIG. 3 while inputting speech [ [symbol] [symbol] [symbol] ]. [ [symbol] [symbol] [symbol] ] in Japanese corresponds to [woman stands with Mt. Fuji in the background] in English. Assume that the picture shown in FIG. 3 includes three strokes 301, 302, and 303, and the user has drawn these strokes 301, 302, and 303 in this order. In FIG. 3, the stroke 301 draws Mt. Fuji, and the strokes 302 and 303 draw the standing woman. This embodiment can support drawing of even such picture including a plurality of objects. The speech input by the user is supplied to the speech recognition unit 101 via the audio input device, and the picture drawn by the user is supplied to the feature extractor 105 via the input interface.

The user's speech is converted into text [ [symbol] [symbol] [symbol] ] by the speech recognition unit 101. Next, the keyword extractor 102 extracts keywords from the text as the recognition result of the speech recognition unit 101.

FIG. 4 shows an example of the processing sequence of the keyword extractor 102. In step S401, the keyword extractor 102 applies morphological analysis to the text received from the speech recognition unit 101 using a morphological analysis technique which is known or will be developed in the future. In the example of this embodiment, assume that the text [ [symbol] [symbol] [symbol] [symbol] ] is analyzed to [symbol] <noun>+ [symbol] <particle>/ [symbol] <noun>+ [symbol] <particle>/ [symbol] <noun>+ [symbol] particle>/+ [symbol] <verb>+ [symbol] <particle>+ [symbol] <auxiliary verb>+ [symbol] <particle>]. Note that a description “OO<XX>” represents that a part of speech of a word “OO” is “XX”, “/” represents a break of a segment, and “+” represents a break of a word. [ [symbol] ] corresponds to [Mt. Fuji], [ [symbol] ] corresponds to [background], [ [symbol] ] corresponds to [woman], and [ [symbol] ] corresponds to [stand].

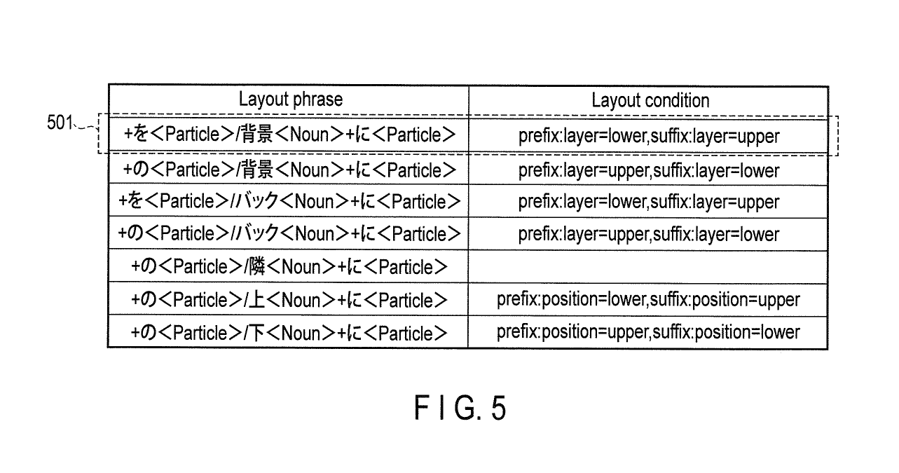

In step S402, the keyword extractor 102 extracts a layout phrase from the morphological analysis result with reference to a layout phrase extraction dictionary exemplified in FIG. 5, and removes that layout phrase from the morphological analysis result. In the layout phrase extraction dictionary shown in FIG. 5, a plurality of layout phrases are registered in association with layout conditions. In the example of this embodiment, a layout phrase [+ [symbol] <particle>/ [symbol] <noun>+ [symbol] <particle>] is extracted with reference to a column 501 of the layout phrase extraction dictionary, and the morphological analysis result is rewritten to [ [symbol] <noun>/ [symbol] <noun>+ [symbol] <particle>/+ [symbol] <verb>+ [symbol] <particle>+ [symbol] <auxiliary verb>+ [symbol] <particle>]. At this time, a layout condition [prefix: layer=lower, suffix: layer=upper] is obtained. The layout condition will be described later.

In step S403, the keyword extractor 102 extracts a word whose part of speech is a noun from the morphological analysis result after the layout phrase is removed. In the example of this embodiment, [ [symbol] ] ([Mt. Fuji]) and [ [symbol] ] ([woman]) are extracted.

In this manner, keywords and a layout phrase are extracted from the speech recognition result by the keyword extractor 102.

Subsequently, the image search unit 104 searches the image storage unit 103 using the words [ [symbol] ] ([Mt. Fuji]) and [ [symbol] ] ([woman]), which are the outputs of the keyword extractor 102, as search words. The image storage unit 103 and image search unit 104 can be implemented by an arbitrary relational database system which is known or will be developed in the future.

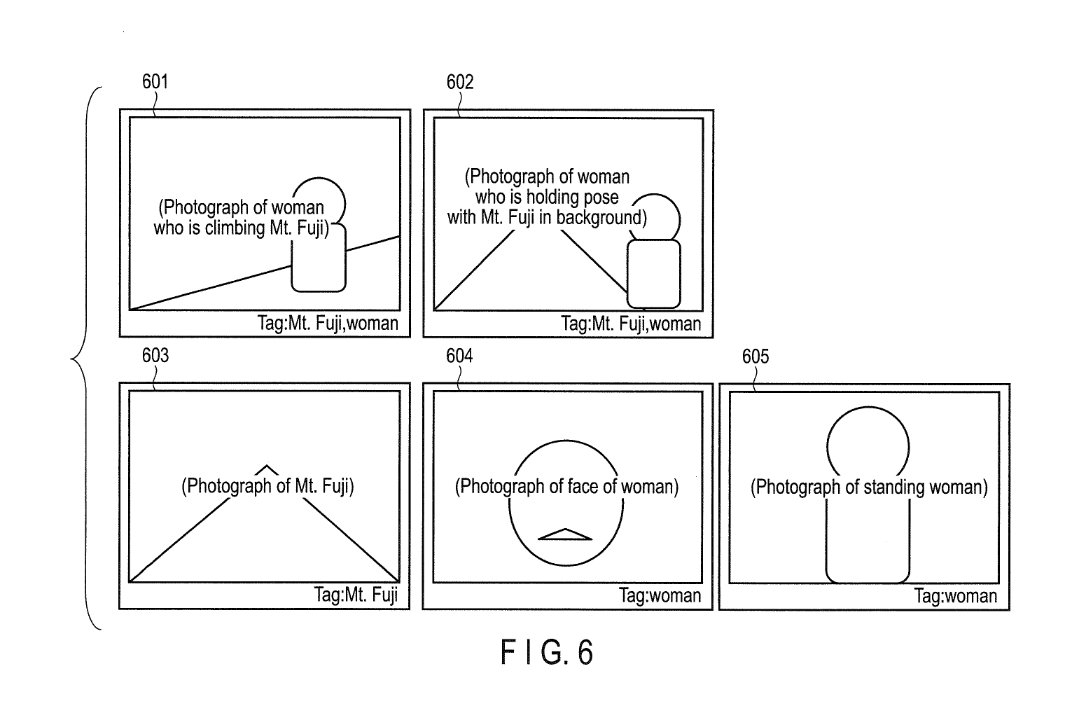

FIG. 6 shows examples of images and tag information stored in the image storage unit 103. FIG. 6 shows five images 601 to 605. The image 601 is a photograph of a woman who is climbing Mt. Fuji, and tag information of this image 601 includes two words [ [symbol] ] ([Mt. Fuji]) and [ [symbol] [symbol] ] ([woman]). The image 602 is a photograph of a woman who is holding a pose with Mt. Fuji in the background, and tag information of the image 602 includes two words [ [symbol] ] ([Mt. Fuji]) and [ [symbol] ] ([woman]). The image 603 is a photograph of Mt. Fuji, and tag information of this image 603 includes a word [ [symbol] ] ([Mt. Fuji]). The image 604 is a photograph of a face of a woman, and tag information of this image 604 includes a word [ [symbol] ] ([woman]). The image 605 is a photograph of a standing woman, and tag information of this image 605 includes a word [ [symbol] ] ([woman]). Note that images stored in the image storage unit 103 are not limited to photographs, and may be those in any other modes such as pictures.

In this example, the images 601 and 602 including both the search words [ [symbol] ] ([Mt. Fuji]) and [ [symbol] ] ([woman]) in their tag information are retrieved. Data items of the retrieved images 601 and 602 are supplied to the feature extractor 105. The feature extractor 105 extracts, from each of the images 601 and 602, a feature amount concerning, for example, contours and lengths of contour lines. As a method of extracting feature amounts from an image, a technique described in, for example, Jpn. Pat. Appln. KOKAI Publication No. 2002-215627 can be used. An example of a feature extraction method will be briefly described below. In the feature extraction method as an example, an image is divided into a plurality of regions in a grid pattern, line segments included in respective regions (handwritten strokes or contour lines extracted from an image) are quantized to simple basic shapes such as [-], [┌], [┐], [|], [└], [ [symbol] ], [ [symbol] ], [ [symbol] ], [ [symbol] ], [⊥], [/], and [\]. Then, which of and how many basic shapes are included, neighboring basic shapes, and the like are extracted.

Furthermore, the feature extractor 105 extracts a feature amount from the picture drawn by the user which is shown in FIG. 3. The feature amount of the drawn picture and feature amounts of the retrieved images are supplied to the image selector 106. The image selector 106 selects an image which matches the drawn picture, from those retrieved by the image search unit 104.

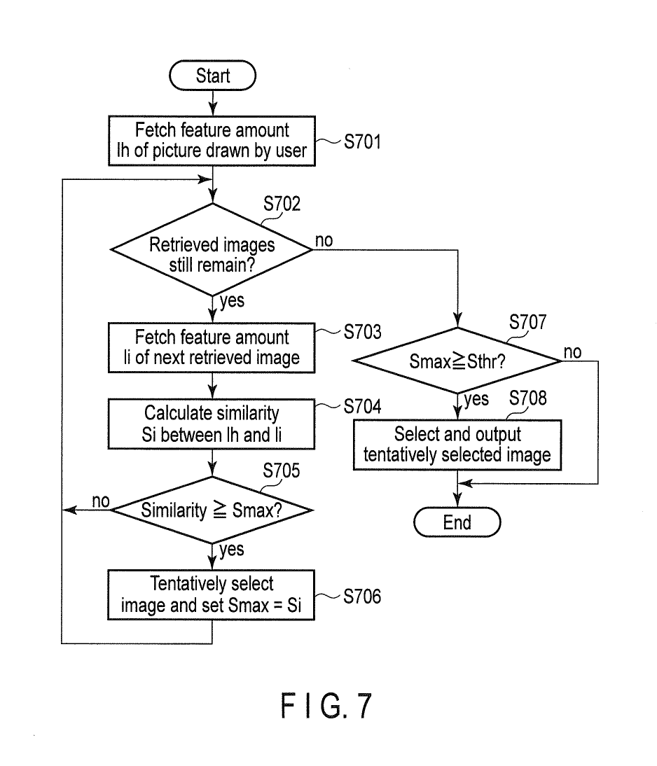

FIG. 7 shows an example of the processing sequence of the image selector 106. In step S701, the image selector 106 fetches a feature amount lh of the drawn picture. The image selector 106 checks in step S702 whether or not images to be processed (that is, images to be selected as an image to be processed) of the retrieved image still remain. If images to be processed still remain, the image selector 106 selects one of the images to be processed as an image to be processed, and the process advances to step S703.

In step S703, the image selector 106 fetches a feature amount li of the image to be processed. In step S704, the image selector 106 calculates a degree of similarity Si between the picture and image to be processed based on the feature amount lh of the picture and the feature amount li of the image to be processed. In step S705, the image selector 106 checks whether or not the degree of similarity Si is not less than a value Smax. Note that at the beginning of the processing of FIG. 7, the value Smax is initialized, and is set to be, for example, zero. If the degree of similarity Si is smaller than the value Smax, the process returns to step S702. On the other hand, if the degree of similarity Si is not less than the value Smax, the process advances to step S706. In step S706, the image selector 106 tentatively selects the image to be processed, and sets the value Smax in the value of the degree of similarity Si. After that, the process returns to step S702.

The processes of steps S703 to S706 are applied to each of the retrieved images. If the image selector 106 determines in step S702 that all the images have been processed, the process advances to step S707. In step S707, the image selector 106 checks whether or not the value Smax is not less than a predetermined threshold Sthr. If the value Smax is less than the threshold Sthr, the image selector 106 does not select any image. If the value Smax is not less than the threshold Sthr, the image selector 106 selects the tentatively selected image as an image which matches the picture drawn by the user in step S708.

In the example of FIG. 7, an image which is most similar to the picture drawn by the user is selected from all images retrieved by the image search unit 104. However, the image selection processing is not limited to such specific example. For example, when the search results of the image search unit 104 are output with certainty factors, retrieved images may be processed in the order of descending the certainty factors, and when an image whose degree of similarity with the picture drawn by the user is larger than the threshold Sthr is found, that image may be selected and output, thus ending the image selection processing.

When the keyword extractor 102 extracts one keyword, the threshold Sthr may be set to be a small value upon starting the image selection processing of FIG. 7. The threshold Sthr may be set to be a small value to eliminate a situation in which the image selector 106 does not select any image, and the image selector 106 may be operated to output even non-similar images as references. The same applies to a case in which images are retrieved using each of a plurality of keywords, as will be described later.

Whether or not the image selector 106 selects an image depends on the predetermined threshold Sthr. In this case, assume that the image selector 106 rejects the image 601 in FIG. 6, and selects the image 602. The image 602 selected by the image selector 106 is supplied to the image deformation unit 107. The feature amount of the selected image 602 and that of the drawn picture are also supplied to the image deformation unit 107.

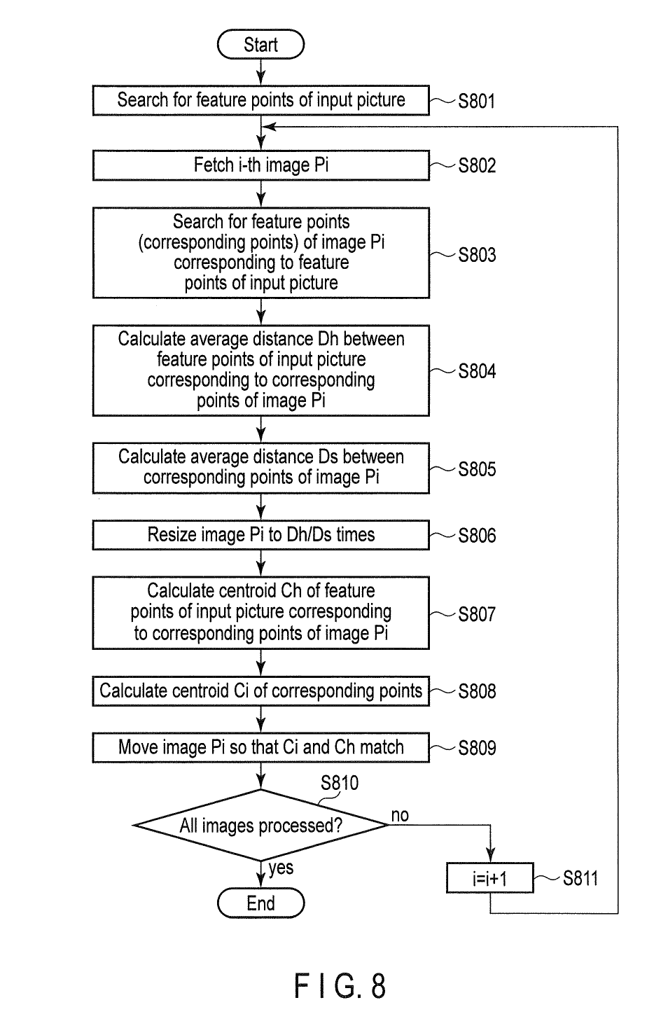

FIG. 8 shows an example of the processing sequence of the image deformation unit 107. In step S801, the image deformation unit 107 searches for feature points of the drawn picture. In step S802, the image deformation unit 107 fetches an i-th image Pi. At the beginning of the deformation processing, i is initialized. That is, i is set to be 1. In this case, the number of images as a deformation processing target is one (image 602).

In step S803, the image deformation unit 107 searches the image Pi for feature points of the image Pi, which correspond to the feature points of the picture. Feature points in the image Pi, which correspond to those of the picture, will be referred to as corresponding points hereinafter. In step S804, the image deformation unit 107 calculates an average distance Dh between the feature points of the picture, which correspond to the corresponding points of the image Pi. In step S805, the image deformation unit 107 calculates an average distance Ds between the corresponding points of the picture Pi. In step S806, the image deformation unit 107 resizes the image Pi to Dh/Ds times.

The image deformation unit 107 calculates a centroid Ch of the feature points of the picture, which correspond to the corresponding points of the image Pi in step S807, and calculates a centroid Ci of the corresponding points of the image Pi in step S808. Subsequently, the image deformation unit 107 moves the image Pi so that the centroids Ch and Ci match (step S809).

In step S810, the image deformation unit 107 checks whether or not the deformation processing has been applied to all images. In this case, since the number of images as deformation processing targets is one, the deformation processing ends.

The image deformation unit 107 supplies the deformed image to the display unit 108 as an output image. The display unit 108 displays the image received from the image deformation unit 107 on a display screen. In this embodiment, the display unit 108 superimposes the picture drawn by the user and the image deformed by the image deformation unit 107 on different layers, and displays them. In this case, the user can execute various kinds of processes such as a process for increasing a transparency of one layer to display a transparent image and processing for erasing the drawn picture to display the deformed image.

Next, support processing executed when the image selector 106 rejects all images (for example, both the images 601 and 602) retrieved by the image search unit 104 and when an image, tag information of which includes all extracted keywords, is not found, will be described below. Note that the support processing to be described below may be used as standard support processing in place of the aforementioned support processing.

When the image selector 106 rejects all images, and when the number of keywords extracted by the keyword extractor 102 is two or more, the image search unit 104 acquires images respectively corresponding to these keywords from the image storage unit 103. In this case, an image, which is retrieved by the first image search processing, is not retrieved again. In this case, assume that the image 603 shown in FIG. 6 is retrieved for the keyword [ [symbol] ] ([Mt. Fuji]), and the images 604 and 605 shown in FIG. 6 are retrieved for the keyword [ [symbol] ] ([woman]).

Subsequently, the image selector 106 selects images which match the picture drawn by the user in correspondence with the respective keywords. At this time, since the respective images are considered to partially correspond to the drawn picture, the threshold Sthr is reduced by multiplying the threshold Sthr by 1/N, where N denotes the number of keywords and is a natural number, and the image selector 106 is operated using that threshold, so as to appropriately select images corresponding to the keywords. In this case, assume that the image 603 shown in FIG. 6 is selected as an image corresponding to the keyword [ [symbol] ] ([Mt. Fuji]), and the image 605 is selected as an image corresponding to the keyword [ [symbol] ] ([woman]).

Next, the image deformation unit 107 deforms the respective images 603 and 605. Referring to FIG. 8 again, the image deformation unit 107 searches for feature points of the drawn picture in step S801. In step S802, the image deformation unit 107 fetches an i-th image Pi. At the beginning of the deformation processing, i is set to be 1. In this example, a first image P1 is the image 603, and a second image P2 is the image 605.

The processes of steps S803 to S809 are the same as those described above, and a description thereof will not be repeated. The image deformation unit 107 checks in step S810 whether or not the deformation processing has been applied to all images. If images to be processed still remain, i is incremented in step S811. After that, the process returns to step S802 to execute the processes of steps S802 to S809 for the next image (for example, the second image 605). After the deformation processing has been applied to all the images, the deformation processing ends.

In this manner, the image 603 shown in FIG. 6 is deformed to fit the size and position of the stroke 301 shown in FIG. 3, and the image 605 shown in FIG. 6 is deformed to fit the size and position of the strokes 302 and 303 shown in FIG. 3.

In the deformation processing sequence shown in FIG. 8, the position and size of the image are deformed. In addition, in order to generate a more natural image as a result of combination processing (to be described later), for example, a transparency of a region outside the corresponding points, which correspond to the picture, may be increased, or blurring processing may be applied to the region.

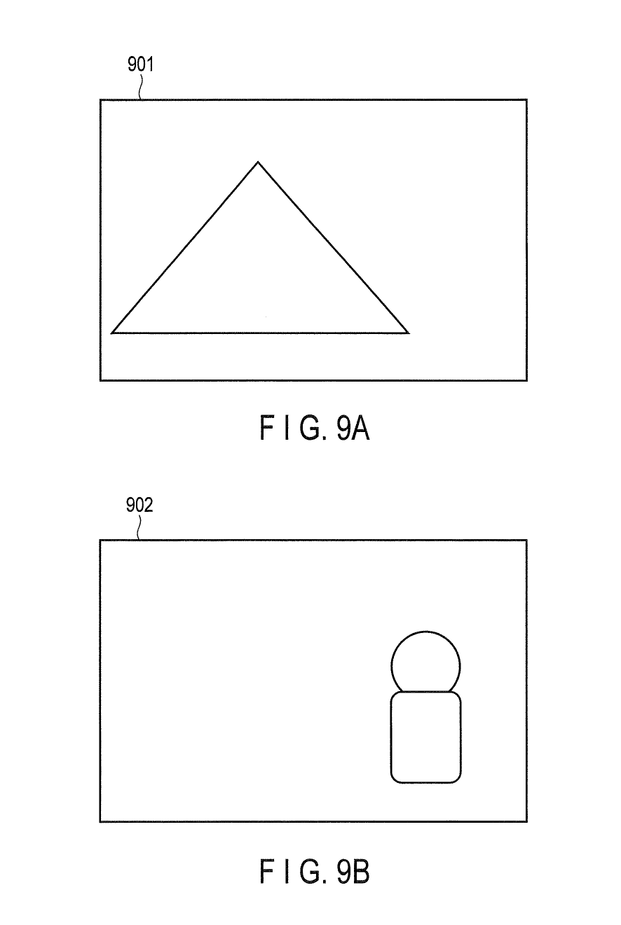

FIGS. 9A and 9B show examples of deformed images. An image 901 shown in FIG. 9A is a deformation result of the image 603 shown in FIG. 6, and an image 902 shown in FIG. 9B is a deformation result of the image 605 shown in FIG. 6.

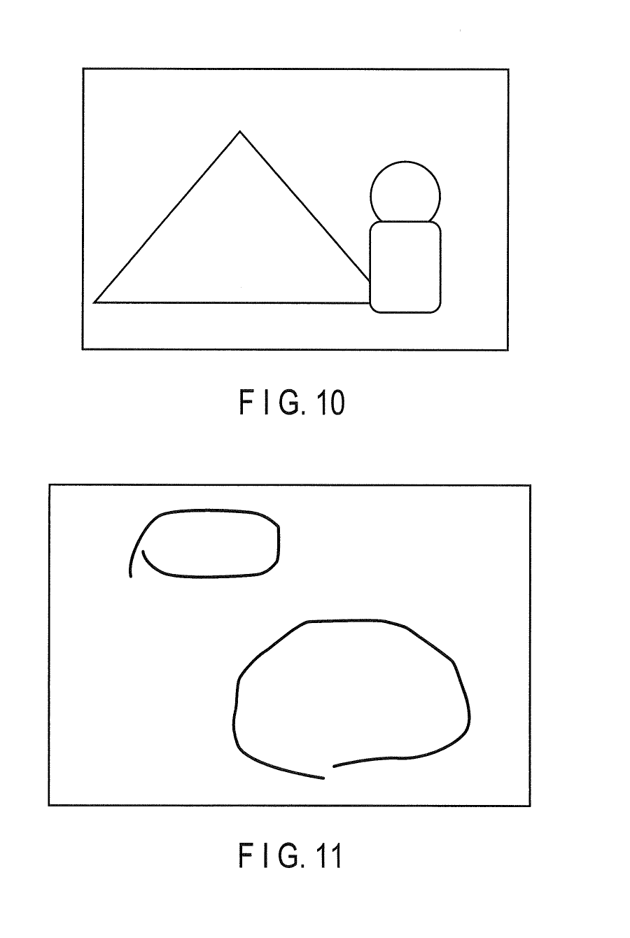

Next, the image deformation unit 107 generates an output image by combining the deformed images (for example, the images 901 and 902). In an example, the image deformation unit 107 combines the images according to the layout condition acquired by the keyword extractor 102. In this case, since the layout condition [prefix: layer=lower, suffix: layer=upper] is obtained, the deformed images are combined, so that the deformed image 901 (image 603) corresponding to [ [symbol] ] ([Mt. Fuji]), which corresponds to the former one of the extracted keywords, is displayed on a lower layer, and the deformed image 902 (image 605) corresponding to [ [symbol] ] ([woman]), which corresponds to the latter keyword, is displayed on an upper layer. FIG. 10 shows the combination result of the deformed images 901 and 902 according to the acquired layout condition.

In this manner, the picture drawing support apparatus according to this embodiment can support the user to draw a picture using images retrieved based on individual keywords even when images (for example, the images 601 and 602), tag information of which includes all extracted keywords, are rejected.

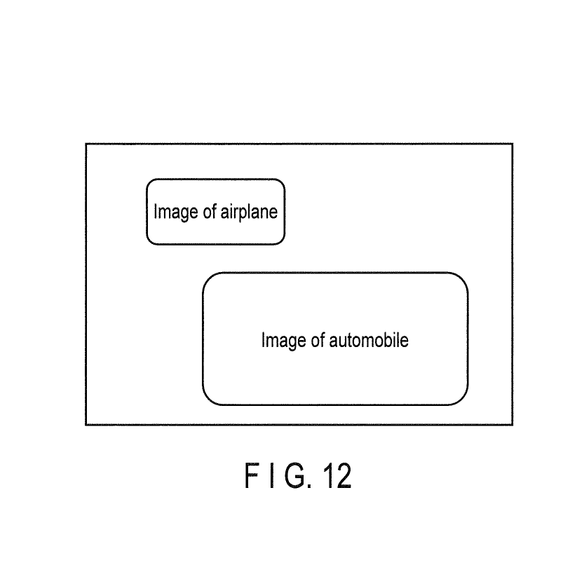

Note that a picture drawn by the user may be evaluated in terms of its complexity, and when a simple picture is input, the threshold Sthr used by the image selector 106 may be set to be small. As a picture complexity evaluation method, a method of determining a higher complexity in accordance with a longer length of a contour line of feature amount obtained by the feature extractor 105, and a method of determining a higher complexity in accordance with a larger number of basic shapes [ [symbol] ], [ [symbol] ], [ [symbol] ], [ [symbol] ], and [⊥] of the quantized basic shapes included in the picture and the like can be used. In this manner, by changing the threshold Sthr according to the complexity of a picture, even when the user draws a simple picture, an image according to the user's intention can be displayed. For example, when the user draws a picture shown in FIG. 11 to indicate positions and sizes of an automobile and airplane while saying [airplane is flying above automobile], an image shown in FIG. 12 can be combined and displayed by laying out images of “automobile” and “airplane” irrespective of the complexity of the picture.

When the user's speech includes a modifying word such as an adjective or adverb, the keyword extractor 102 may generate relation information indicating a modification relation between the modifying word and keyword, and the image deformation unit 107 may control a combination method based on the relation information. For example, when the speech contents of the user are [woman stands with misty Mt. Fuji in the background], the image deformation unit 107 blurs the deformed image 901 corresponding to Mt. Fuji, and then combines the deformed images 901 and 902.

Furthermore, the image storage unit 103 may store images in association with their use counts (for example, selection counts of images by the image selector 106). Use counts of images relate to trends in pictures drawn by the user, that is, user's preferences. When there are a plurality of images having nearly equal degrees of similarity with the drawn picture, the image selector 106 selects an image having a larger use count, thus reflecting the user's preference to the drawing support processing.

As described above, the picture drawing support apparatus according to this embodiment selects an image which matches a picture drawn by the user using speech recognition, and deforms this image to fit the picture, thereby generating an output image. In this way, the apparatus supports the user to easily draw a desired picture. Furthermore, the user can continuously draw even a picture including a plurality of objects by a natural operation.

Instructions in the processing sequences described in the aforementioned embodiment can be executed based on a program as software. A general-purpose computer system stores this program in advance and loads the stored program, thus obtaining the same effects as those obtained by the picture drawing support apparatus of the aforementioned embodiment. The instructions described in the aforementioned embodiment are recorded as a program which can be executed by a computer in a magnetic disk (flexible disk, hard disk, etc.), optical disk (CD-ROM, CD-R, CD-RW, DVD-ROM, DVD±R, DVD±RW, etc.), semiconductor memory, or similar recording medium. A storage format of a recording medium is not particularly limited as long as the recording medium is readable by a computer or embedded system. The computer loads the program from this recording medium, and controls a CPU to execute instructions described in the program based on this program, thus implementing the same operation as the picture drawing support apparatus of the aforementioned embodiment. Naturally, the computer may acquire or load the program via a network.

Further, an OS (Operating System), database management software, MW (middleware) for a network, or the like, which runs on a computer, may execute some of the processes required to implement this embodiment based on instructions of a program installed from the recording medium in a computer or embedded system.

Furthermore, the recording medium of this embodiment is not limited to a medium that is separate from a computer or embedded system, and includes a recording medium, which stores or temporarily stores a program downloaded via a LAN, the Internet, or the like.

The number of recording media is not limited to one, and the recording medium of this embodiment includes the case in which the processing of this embodiment is executed from a plurality of media. That is, the medium configuration is not particularly limited.

Note that the computer or embedded system of this embodiment is used to execute respective processes of this embodiment based on the program stored in the recording medium, and may have an arbitrary arrangement such as a single apparatus (for example, a personal computer, microcomputer, etc.), or a system in which a plurality of apparatuses are connected via a network.

The computer of this embodiment is not limited to a personal computer, and includes an arithmetic processing device, microcomputer, or the like included in an information processing apparatus, and is a generic name of a device and apparatus, which can implement the functions of this embodiment based on the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A picture drawing support apparatus comprising:
a feature extractor configured to extract a feature amount from a picture drawn by a user;
a speech recognition unit configured to perform speech recognition on speech input by the user;
a keyword extractor configured to extract at least one keyword from a result of the speech recognition;
an image search unit configured to retrieve one or more images corresponding to the at least one keyword from a plurality of images prepared in advance;
an image selector configured to select an image which matches the picture, from the one or more images based on the feature amount;
an image deformation unit configured to deform the selected image based on the feature amount to generate an output image; and
a presentation unit configured to present the output image.

2. The apparatus according to claim 1, wherein the image selector calculates degrees of similarity between the picture and the one or more images based on the feature amount, and selects an image which matches the picture, based on comparisons between the degrees of similarity and a predetermined threshold.

3. The apparatus according to claim 2, wherein when the keyword extractor extracts a plurality of keywords and the image selector determines based on the comparisons that the one or more images do not include an image which matches the picture, the image search unit retrieves a plurality of images corresponding to the plurality of keywords, one or more images for each keyword, the image selector selects images which match parts of the picture from the plurality of images, and the image deformation unit combines the selected images.

4. The apparatus according to claim 2, wherein when the picture is a simple figure and the image selector determines based on the comparison that the one or more images do not include an image which matches the picture, the image selector selects an image having a highest degree of similarity from the one or more images, and the image deformation unit deforms the selected image based on a size and a position of the picture.

5. The apparatus according to claim 2, wherein the feature extractor extracts other feature amounts from the one or more images, and calculates the degrees of similarity based on the feature amount and the other feature amounts.

6. The apparatus according to claim 1, wherein when the keyword extractor extracts a plurality of keywords, the image deformation unit generates a plurality of deformed images by deforming a plurality of images which are selected respectively for the plurality of keywords, and generates an output image by combining the plurality of deformed images.

7. The apparatus according to claim 6, wherein the keyword extractor acquires relation information indicating a modification relation in the result of the speech recognition, and the image deformation unit controls a combination method of the plurality of deformed images in accordance with the relation information.

8. The apparatus according to claim 7, wherein the relation information includes a modification relation between the keyword and a modifying word, which modifies the keyword.

9. A picture drawing support method comprising:
extracting a feature amount from a picture drawn by a user;
performing speech recognition on speech input by the user;
extracting at least one keyword from a result of the speech recognition;
retrieving one or more images corresponding to the at least one keyword from a plurality of images prepared in advance;
selecting an image which matches the picture, from the one or more images based on the feature amount;
deforming the image based on the feature amount to generate an output image; and
presenting the output image.

10. The method according to claim 9, wherein the selecting comprises calculating degrees of similarity between the picture and the one or more images based on the feature amount, and selecting an image which matches the picture, based on comparisons between the degrees of similarity and a predetermined threshold.

11. The method according to claim 10, wherein when the at least one keyword includes a plurality of keywords and it is determined based on the comparisons that the one or more images do not include an image which matches the picture, the retrieving comprises retrieving a plurality of images corresponding to the plurality of keywords, one or more images for each keyword, the selecting comprises selecting images which match parts of the picture from the plurality of images, and the deforming comprising combining the selected images.

12. The method according to claim 10, wherein when the picture is a simple figure and it is determined based on the comparison that the one or more images do not include an image which matches the picture, the selecting comprises selecting an image having a highest degree of similarity from the one or more images, and the deforming comprises deforming the selected image based on a size and a position of the picture.

13. The method according to claim 10, further comprising extracting other feature amounts from the one or more images, wherein the calculating the degrees of similarity is based on the feature amount and the other feature amounts.

14. The method according to claim 9, wherein when the at least one keyword comprises a plurality of keywords, the deforming comprises generating a plurality of deformed images by deforming a plurality of images which are selected respectively for the plurality of keywords, and generating an output image by combining the plurality of deformed images.

15. The method according to claim 14, further comprising acquiring relation information indicating a modification relation in the result of the speech recognition, wherein the deforming comprises controlling a combination method of the plurality of deformed images in accordance with the relation information.

16. The method according to claim 15, wherein the relation information includes a modification relation between the keyword and a modifying word, which modifies the keyword.

17. A non-transitory computer readable medium including computer executable instructions, wherein the instructions, when executed by a processor, cause the processor to perform a method comprising:
extracting a feature amount from a picture drawn by a user;
performing speech recognition on speech input by the user;
extracting at least one keyword from a result of the speech recognition;
retrieving one or more images corresponding to the at least one keyword from a plurality of images prepared in advance;
selecting an image which matches the picture, from the one or more images based on the feature amount;
deforming the image based on the feature amount to generate an output image; and
presenting the output image.
